(19) United States
(12) Patent Application Publication
(10) Pub. No.: US 2008/0316887 A1
(43) Pub. Date: Dec. 25, 2008

(54) Game system and method employing reversible voice recorder

(76) Inventors: Mark J. Chernick, Woodinville, WA (US); Webb T. Nelson, Woodinville, WA (US)

Correspondence Address: LAMORTE & ASSOCIATES P.C., P.O. BOX 434, YARDLEY, PA, 19067, US

(21) Appl. No.: 11/820,506

(22) Filed: Jun. 21, 2007

(51) Int. Cl. G11B 31/00

(52) U.S. Cl. 369/63

(57) ABSTRACT

A handheld recording device and a method of play that can be played with either one or two recording devices. Each recording device has a microphone for converting sound into an electronic sound signal. The recording device also has a digital memory with a limited sound recording capacity. The digital memory records the sound signal when a record button is pressed. A backward play button is also located on the recording device. The backward play button causes any sound signal recorded in the digital memory to play backward and be broadcast through a speaker. A game is played using one or two of the recording devices. A first player records a message and plays it backwards. The other players can decipher the backward message by recording it in their own recording device and playing the backward message in reverse.

### BACKGROUND OF THE INVENTION

1. Field of the Invention

In general, the present invention relates to voice recording mechanisms that are capable of playing recorded sounds backwards. More particularly, the present invention relates to games and methods of play that use such voice recording mechanisms.

2. Prior Art Description

Shortly after Thomas Edison introduced the first phonograph, people discovered that if recordings were run in reverse, the recording would play backward. This was the first time in history that people had the technological ability to play recorded words and music in reverse. Listening to backward words fascinates many people, especially children and young adults. Words heard backwards sound like a foreign language having a unique cadence and vocabulary. Knowing that the sounds being heard are regular words pronounced backwards, people inevitably try to decipher the words by mentally reversing the sounds of the backward words.

Until recently, it has been difficult to record words and play them backwards. Prior to the invention of magnetic tape, recordings would have to be recorded in wax or vinyl and played backwards. This was a difficult and costly activity. After the advent of magnetic tape and tape recorders, people could more readily record words and play them backwards. However, using a tape recorder has its own problems. Tape recorders that can play backwards are complex, expensive devices that are usually marketed only to sound recording professionals. Furthermore, tape recorders are typically designed to have long recording times. It is difficult, especially for a child, to make a specific recording somewhere on a long tape and then later queue the tape to the exact point, beginning or end, of the recording.

U.S. Pat. No. 6,182,966 to Wells, entitled Language Board Game discloses a board game that uses a tape recorder to record the players' voices and play those voices backwards. However, the Wells board game is complex, both in the hardware that it uses and its method of play, making the game inappropriate for children.

With the development of digital technology, recorders do exist that record sound directly into a memory circuit rather than upon magnetic tape. Digital recordings can be electronically tagged so that specific recordings can be instantly queued for playback. Although digital recorders exist, the technology has still only been utilized primarily in traditional recording devices such as answering machines and dictaphones. In very few applications has the technology been incorporated into devices for children.

The present invention is a simplified voice recording system specifically designed for use by children and games that can be played with such a voice recording system. The details of the present invention are described and claimed below.

### SUMMARY OF THE INVENTION

The present invention is a handheld recording device and a method of play that can be played with either one or two aforementioned recording devices. The recording device has a microphone for converting sound into an electronic sound signal. The recording device also has a digital memory with a limited sound recording capacity. A record button is present on the recording device. The record button is pressed to start a recording on the digital memory. The digital memory automatically clears any previous recording in the digital memory the moment a record button is pressed. A backward play button is also located on the recording device. When the backward play button is pressed, the digital memory automatically queues to the end of the recorded message and begins to play the recorded message backwards.

A game is played using one or two of the recording devices. A first player records a message into a recording device and plays it backward for other players to hear. The other players can decipher the backward message by recording it in their own recording device and playing the backward message in reverse. Alternatively, players can attempt to mentally decipher the backward message and play the backward message forward only to confirm a player's guess.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of a set of recording devices in accordance with the present invention;

FIG. 2 is a schematic of one of the recording devices shown in FIG. 1;

FIG. 3 is a block diagram showing an exemplary method of operation for the set of recording devices shown in FIG. 1;

FIG. 4 shows a recoding device set in an exemplary embodiment of a store shelf packaging;

FIG. 5 shows an alternate embodiment of a recording device; and

FIG. 6 shows a method using a recording device.

### DETAILED DESCRIPTION OF THE DRAWINGS

The present invention recording device is a compilation of electronic components that are held in a housing. It will be understood that the shape of the housing is a matter of design choice. The exemplary embodiment of the present invention recording device shows one specific housing that is the selected design of the inventor. The selection of the housing design is only exemplary and should not be considered a limitation on the invention as defined by the claims.

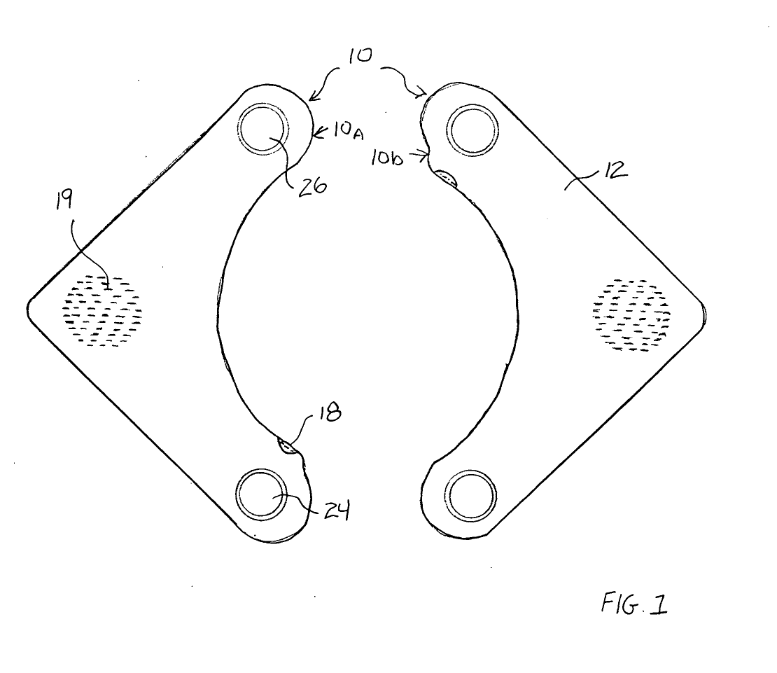

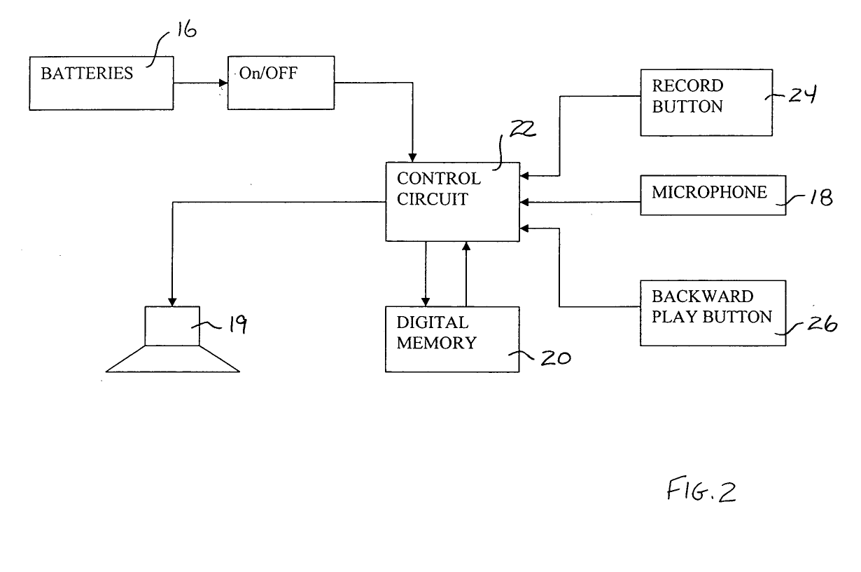

In FIG. 1, a set of recording devices 10 are shown. The two recording devices 10 are identical. The recording devices 10 are shown as a matched pair for preferred methods of play that are later explained. In FIG. 2, a schematic for one of the recording devices 10 is shown. Referring to FIG. 1 in conjunction with FIG. 2, it will be understood that each recording device 10 has a housing 12 that is sized to easily fit in the hand of a child. Each recording device 10 is battery powered and therefore contains a battery compartment for holding batteries 16. Although the recording device 10 can operate on many types of batteries, it is preferred that the recording device run upon low cost “AA” or “AAA” sized batteries.

Each recording device 10 has a microphone 18 for receiving sound energy and a speaker 19 for broadcasting sound energy. A digital memory 20 is provided. The digital memory 20 has the ability to retain a single recording that has a specific time duration. Preferably, the digital memory 20 has the capacity to retain sound recordings of between five seconds and fifteen seconds, with the preferred duration being between six and ten seconds. However, recording time of up to one minute can be used. The short duration is an important aspect to the functionality of the invention, as will later be explained. An added benefit is that a digital memory 20 having such a limited capacity can be produced at a very low cost.

The digital memory 20, microphone 18 and speaker 19 are all connected to a control circuit 22. The control circuit 22 takes an analog signal from the microphone 18 and converts it to a digital signal that can be stored in the digital memory 20. Likewise, the control circuit 22 takes the digital signal stored in the digital memory 20 and converts it to an analog signal that can be played through the speaker 19.

When a sound recording is saved to the digital memory 20 and when a sound recording is played from the digital memory 20, both functions are governed by a user's manipulation of two primary control buttons. The two primary control buttons include a record button 24 and a backward play button 26. When the record button 24 is pressed, the control circuit 22 first automatically clears the digital memory 20 of any previous recording. The control circuit 22 then feeds sound energy from the microphone 18 to the digital memory 20 for as long as the record button 24 is pressed or for the duration of the recording capacity of the digital memory 20. As such, it will be understood that once the record button 24 is pressed, all sounds detected by the microphone 18 will be recorded into the digital memory 20. Once the record button 24 is released or the allotted time frame passes, recording automatically stops. The sound signal recorded into the digital memory 20 remains preserved in the digital memory 20 until the record button 24 is again pressed. If the record button 24 is pressed again, the new sound signal replaces the old sound signal and the old sound signal is lost.

To play the sound signal that is recorded into the digital memory 20, a user presses the backward play button 26. As implied by the name, the backward play button 26 causes the sound signal to be broadcast backward through the speaker 19. Accordingly, if a user recorded “Mary has a little lamb”, it will be broadcast as “bmal elttil a sah yram”.

No issues of sound queuing exist. The digital memory 20 automatically queues to the end of the recorded sound recording. Every time the record button 24 is pressed, the previous recording is automatically erased in full. Each time the backward play button 26 is pressed, the full new recording is played backward from its end to its beginning. Since the digital memory 20 always plays the full recording, a recording cannot be stopped at some mid-point. There is, therefore, no need to queue the recording.

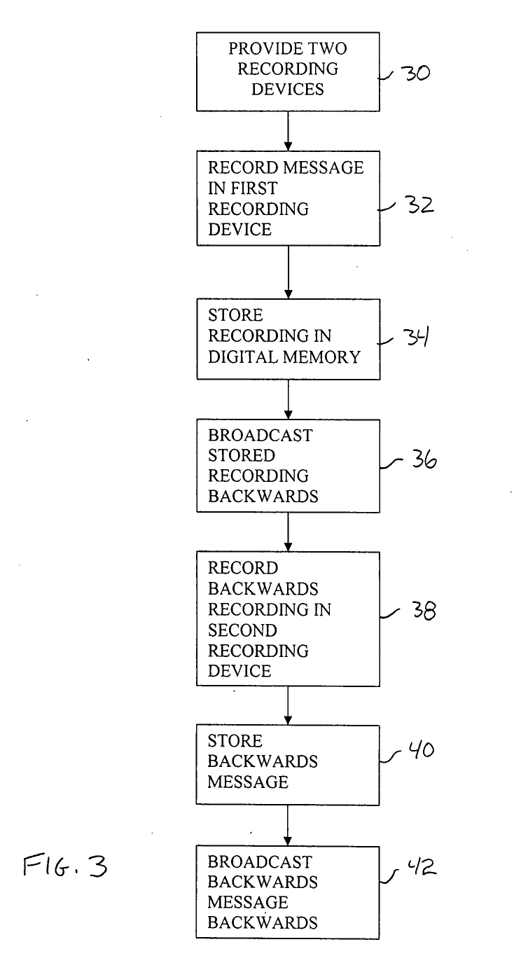

Referring to FIG. 3 in conjunction with FIG. 1, the use of a set of recording devices 10 can now be explained. As is indicated by Block 30, two recording devices 10 are provided to two users. As is indicated by Block 32, a first user presses the record button 24 on a first of the recording devices 10a and verbalizes a message. The message is recorded into the digital memory 20 of the first recording device 10a, as is indicated by Block 34. The first user can play the recorded message by pressing the backward play button 26. See Block 36. Of course, when the backward play button 26 is pressed, the recorded message is played aloud in reverse. A person hearing the message played aloud would not understand the message, since it is being broadcast in reverse. The message is therefore coded, being that it is not understandable to a casual listener.

To decode the message, a second recording device 10b is needed. The backward coded message of the first recording device 10a can be recorded by the second recording device 10b. See Block 38. This is done by pressing the record button 24 on the second recording device 10b at the same time that the backward play button 26 is played on the first recording device 10a. The backward coded message is recorded into the digital memory 20 of the second recording device 10b. See Block 40. When the backward play button 26 on the second recording device 10b is pressed, the backward coded message is played backward, thereby being in plain forward English. See Block 42. It will therefore be understood that the first recording device 10a allows a message to be coded by being broadcast in reverse. A second recording device 10b is required to decipher the backward coded message by recording it again and reversing the backward recorded message back into its proper linguistic form.

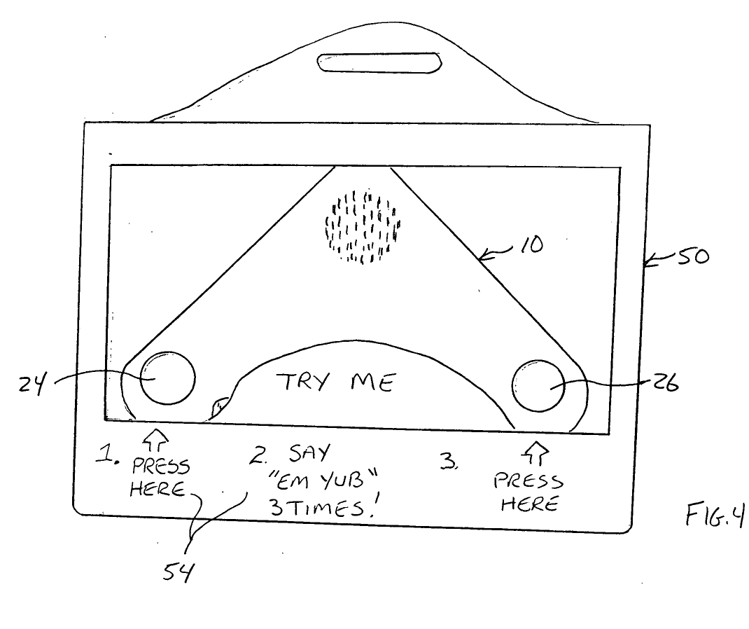

Referring to FIG. 4, a recoding device 10 is shown in packaging 50. The packaging 50 has access openings 52 over the record button 24 and the backward play button 26. On the packaging is a “Try Me” solicitation 54. The solicitation 54 instructs a potential buyer to press the record button 24, state a selected phrase and then press the backward play button 26. The selected phrase can be “em yub” or another backward promotional phrase. When the potential buyer presses the record button 24, states “em yub” and presses the backward play button 26, “em yub” is played backward. The potential buyer will then hear “em yeb” played backward, which is “buy me”.

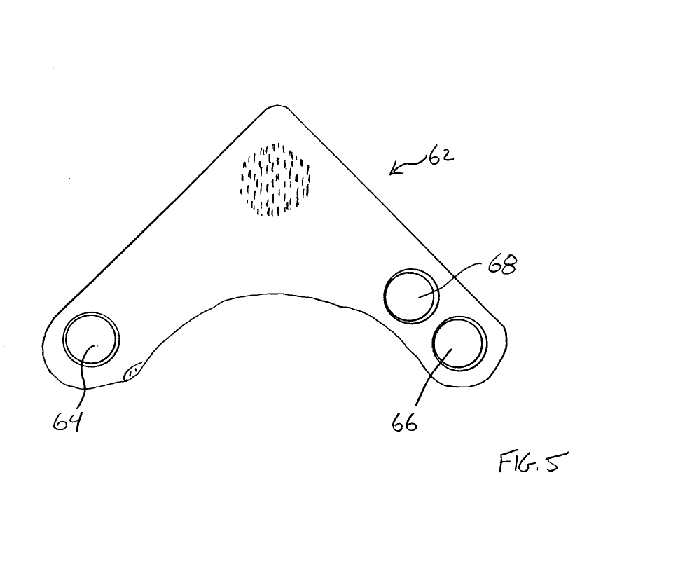

Referring to FIG. 5, a modified recording device 62 is shown. The modified recording device 62 has both a record button 64 and a backward play button 66, like in the embodiment previously described. However, a third forward play button 68 is now provided. The forward play button 68 causes the sound signal stored in the digital memory to be played forward, like a traditional recorder. Using the modified recording device 62, a user can record a word or phrase and then play it back in either the forward direction or the backward direction. In this manner, the modified recording device 62 can take the place of the two recording devices shown originally in FIG. 1.

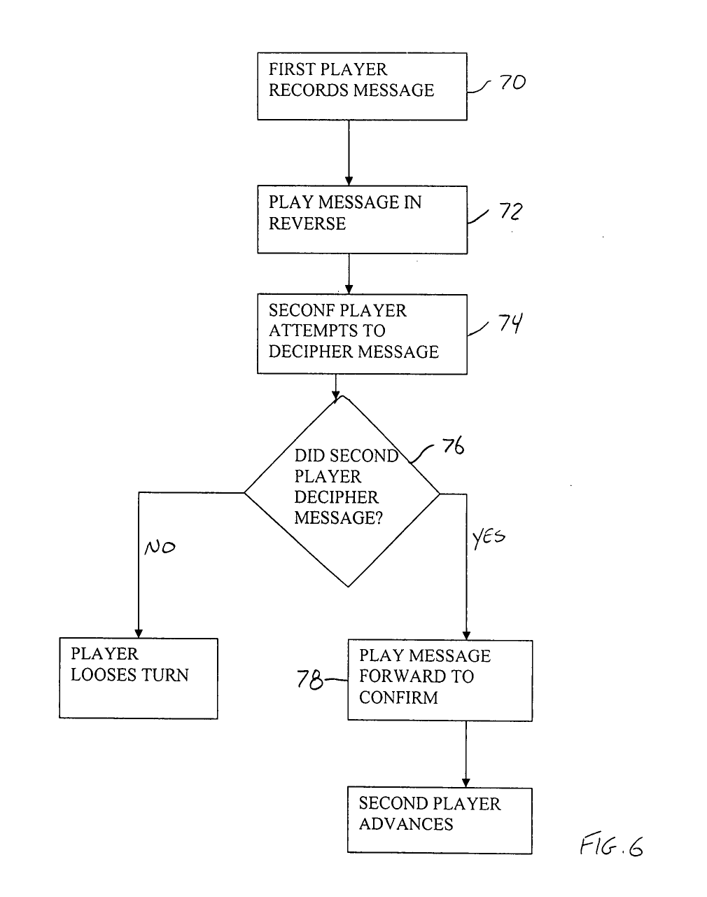

Referring to FIG. 6, a method of play is described. The method of play can be accomplished using the pair of recording devices illustrated in FIG. 1 or the modified recording device illustrated in FIG. 5. Using either configuration, a first player records a message comprised of a word or phrase, while out of earshot of other players. See Block 70. The message can be random or it can be some word or phrase selected from a list or card that is preprinted and supplied as part of a game assembly. Complex words and phrases can be assigned higher point values than simple words and phrases. After the word or phrase is recorded, it is played in reverse to the other players. See Block 72. The other players then try to decipher the word or phrase. See Block 74. This can be done mentally or by writing the sounds heard down on a piece of paper and then trying to read that message backwards. The first player to call out the correct word or phrase wins. This earns the player points or advances the player along some game board. The correct answer can be verified by reversing the backward message using the recording device and playing the message in plain forward English. See Blocks 76 and 78.

It will be understood that the embodiments of the present invention that have been illustrated and described are merely exemplary and that a person skilled in the art can make many variations to those embodiments using functionally equivalent components. For instance, the shape of the recording device and the position of the buttons, microphone and speaker on the recording device is a matter of design choice. All such variations, modifications and alternate embodiments are intended to be included within the scope of the present invention as defined by the claims.

What is claimed is:

1. A handheld recording device, comprising:
a microphone for converting sound into an electronic sound signal;
a record button;
a digital memory having a sound recording capacity of no more than sixty seconds, wherein said digital memory records said sound signal when said record button is pressed;
a speaker; and
a backward play button for causing said sound signal recorded in said digital memory to play backward though said speaker.

2. The device according to claim 1, wherein any sound signal present in said digital memory is erased in full when said record button is first pressed, thereby clearing said digital memory for a new sound signal recording.

3. The device according to claim 1, further including a forward play button that causes said sound signal recorded in said digital memory to play forward through said speaker.

4. The device according to claim 1, wherein said digital memory has a sound recording capacity of less than fifteen seconds.

5. The device according to claim 1, wherein said digital memory has a sound recording capacity of between five seconds and ten seconds.

6. A method comprising the steps of:
providing a set of recording devices, that includes a first recording device and a second recording device, wherein both said first recording device and said second recording device have a digital memory that has a limited audible recording capacity;
recording a message on said first recording device;
playing said message in reverse from said first recording device, therein producing a backward message;
recording said backward message on said second recording device; and
playing said backward message in reverse from said second recording device.

7. The method according to claim 6, wherein said step of providing a set of recording devices includes providing a set of recording devices that can only play recorded messages in reverse.

8. The method according to claim 6, wherein said first recording device is held by a first person, and said second recording device is held by a second person.

9. The method according to claim 8, further including having said second person attempt to decipher said backward message prior to playing said backward message in reverse from said second recording device.

10. The method according to claim 6, wherein said limited audible recording capacity is less than sixty seconds.

11. The method according to claim 6, wherein said limited audible recording capacity is less than fifteen seconds.

12. A method comprising the steps of:
providing a recording device having a digital memory that has a limited audible recording capacity;
recording a message on said recording device;
playing said message in reverse from said recording device, therein producing a backward message;
having players attempt a guess to decipher said backward message; and
playing said message forward from said recording device to confirm said guess.

13. The method according to claim 12, wherein said step of recording a message includes pressing a record button on said recording device and verbalizing said message.

14. The method according to claim 13, further including the step of clearing said digital memory of any previously recorded message the moment said record button is pressed.

15. The method according to claim 12, wherein said digital memory has a limited audible recording capacity of no more than sixty seconds.

16. The method according to claim 12, wherein said digital memory has a limited audible recording capacity of between five seconds and ten seconds.
